(19) United States
(12) Patent Application Publication
(10) Pub. No.: US 2021/0295274 A1
(43) Pub. Date: Sep. 23, 2021

(54) WORKFLOW MANAGEMENT DEVICE, WORKFLOW MANAGEMENT SYSTEM, METHOD OF MANAGING WORKFLOW, AND NON-TRANSITORY RECORDING MEDIUM

(71) Applicant: Ricoh Company, Ltd., Tokyo (JP)

(72) Inventor: Shohei ARAI, Kanagawa (JP)

(73) Assignee: Ricoh Company, Ltd., Tokyo (JP)

(21) Appl. No.: 17/144,211

(22) Filed: Jan. 8, 2021

(30) Foreign Application Priority Data
Mar. 19, 2020 (JP) 2020-050159

(51) Int. Cl. G06Q 10/10; G06F 3/14; G06Q 10/06

(52) U.S. Cl. CPC G06Q 10/1097; G06Q 10/0633; G06F 3/14

(57) ABSTRACT

A workflow management device includes circuitry that acquires schedule information indicating a schedule of a specific person. The specific person is to perform a specific task in a workflow. The specific task is required to be performed at a specific place. The circuitry determines, based on the acquired schedule information, at least one period of time in which the specific person is at the specific place and available for performing the specific task. The at least one period of time including one or more time slots. The circuitry transmits information on the at least one period of time to a terminal device used by an applicant of the workflow.

### CROSS-REFERENCE TO RELATED APPLICATION

This patent application is based on and claims priority pursuant to 35 U.S.C. § 119(a) to Japanese Patent Application No. 2020-050159, filed on Mar. 19, 2020, in the Japan Patent Office, the entire disclosure of which is hereby incorporated by reference herein.

### BACKGROUND

### Technical Field

Embodiments of the present disclosure relate to a workflow management device, a workflow management system and a method of managing a workflow, and a non-transitory recording medium storing instructions for executing a method of managing a workflow.

### Related Art

In a workflow management system that is used to apply, review, and approve with respect to a purchase requisition or transportation expense reimbursement, a technique for predicting a time required for an approval process or a technique for automatically setting an approval deadline is already known.

As such a workflow management system, for a purpose of preventing a project schedule from being delay, there is a configuration in which, based on schedule information of an approver set in a workflow, one or more time slots in which the approver is available are determined and a schedule for a settlement is determined accordingly.

### SUMMARY

An exemplary embodiment of the present disclosure includes a workflow management device including circuitry that acquires schedule information indicating a schedule of a specific person. The specific person is to perform a specific task in a workflow. The specific task is required to be performed at a specific place. The circuitry determines, based on the acquired schedule information, at least one period of time in which the specific person is at the specific place and available for performing the specific task. The at least one period of time including one or more time slots. The circuitry transmits information on the at least one period of time to a terminal device used by an applicant of the workflow.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of an overall configuration of a workflow management system according to one or more embodiments;

FIG. 2 is a block diagram illustrating an example of a hardware configuration of a workflow management server or the like according to one or more embodiments;

FIG. 3 is a diagram illustrating an example of a functional block configuration of a workflow management system according to one or more embodiments;

FIG. 4 is a conceptual diagram illustrating an example of a workflow table, according to one or more embodiments;

FIG. 5 is a conceptual diagram illustrating an example of a workflow instance table, according to one or more embodiments;

FIG. 6 is a conceptual diagram illustrating an example of an input item table, according to one or more embodiments;

FIG. 7 is a conceptual diagram illustrating an example of a workflow instance input value table, according to one or more embodiments;

FIG. 8 is a conceptual diagram illustrating an example of a schedule table, according to one or more embodiments;

FIG. 9 is a flowchart illustrating an example of how a workflow is performed, according to one or more embodiments;

FIG. 10 is a sequence diagram of an example of an execution process of a workflow, according to one or more embodiments;

FIG. 11 is an illustration of an example of a workflow selection screen, according to one or more embodiments;

FIG. 12 is an illustration of an example of a workflow input screen, according to one or more embodiments;

FIG. 13 is a flowchart illustrating an example of a workflow having two or more tasks each of which requires approval, according to one or more embodiments; and

FIG. 14 is a flowchart illustrating an example of a workflow that includes an approval process that is to be performed in a factory, according to one or more embodiments.

The accompanying drawings are intended to depict example embodiments of the present disclosure and should not be interpreted to limit the scope thereof. The accompanying drawings are not to be considered as drawn to scale unless explicitly noted.

### DETAILED DESCRIPTION

The terminology used herein is for describing particular embodiments only and is not intended to be limiting of the present disclosure. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof. In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operation in a similar manner, and achieve a similar result.

Hereinafter, a workflow management device, a workflow management system, a workflow management method, and a non-transitory recording medium storing a program according to one or more embodiments of the present disclosure are described with reference to the accompanying drawings. The present disclosure, however, is not limited to the following one or more embodiments, and the constituent elements of the following one or more embodiments include elements that may be easily conceived by those skilled in the art, those being substantially the same ones, and those being within equivalent ranges. Furthermore, various omissions, substitutions, changes and combinations of the constituent elements may be made without departing from the gist of the following one or more embodiments.

In the description of the one or more embodiments given below, the following terms are defined or have meaning as described below. Computer software, which may be, hereinafter, simply referred to as “software”, is defined as a program related to operation of a computer or any data to be used in processing performed by a computer according to such a program. “Application software”, which may be simply referred to as an “application”, is a general term for any software used to perform certain processing. “Operating system”, which is hereinafter simply referred to as an “OS”, is software for controlling a computer, such that software, such as application software, is able to use computer resources. The operating system controls the computer and performs basic operation and management, such as input or output of data, management of hardware resources such as a memory or a hard disk, and management of processes. Application software operates by utilizing functions provided by the operating system. “Program” is defined as a set of instructions for causing a computer to perform processing to have a certain result. While data to be used in processing according to the program is not a program itself, such data may define processing to be performed by the program such that it may be interpreted as equivalent to the program. For example, a data structure, which is a logical structure of data described by an interrelation between data elements, may be interpreted as equivalent to the program.

In an embodiment given hereinafter, an approval process is used as an example of a target process (a specific task) for which a time is set, or scheduled, and inside of a company, namely an office, is used as an example of a specific place at which the target process (approval process) is allowed to be performed. That is, an approver who is a worker, or a specific person, for performing the specific task corresponding to the approval process and authorized to complete the approval process is required to be at the office (works at the company) in order to complete the approval process.

Overall Configuration of Workflow Management System

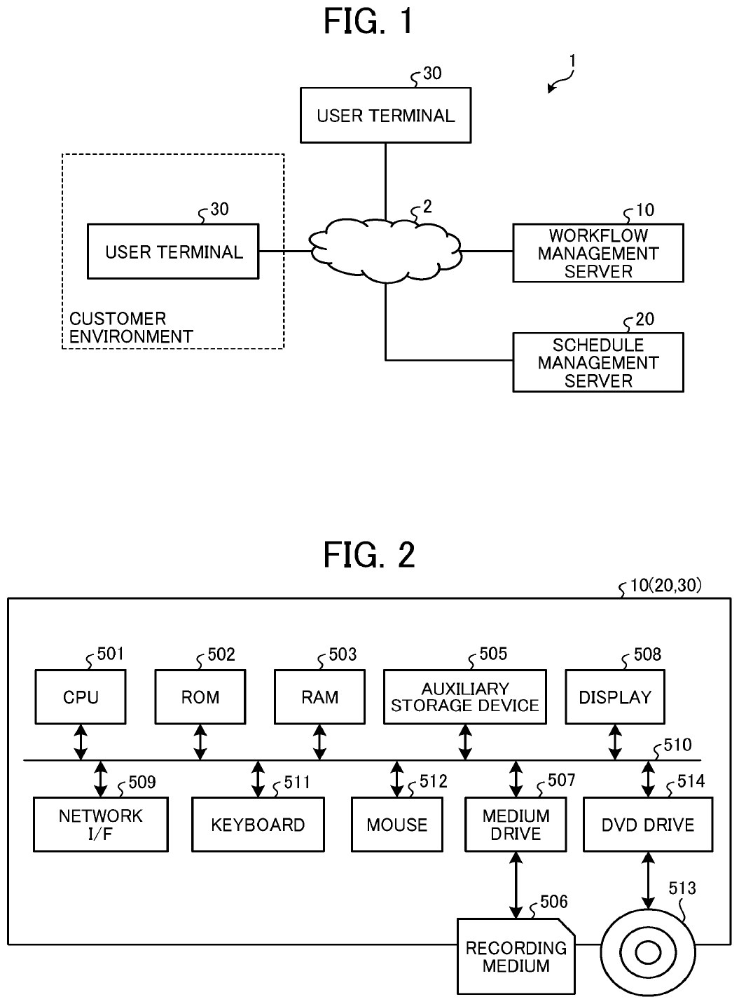

FIG. 1 is a diagram illustrating an example of an overall configuration of a workflow management system according to the present embodiment of the disclosure. A description is given below of the overall configuration of a workflow management system 1 according to the present embodiment with reference to FIG. 1.

The workflow management system 1 illustrated in FIG. 1 is a system for executing a specific workflow and managing the progress of the workflow. As illustrated in FIG. 1, the workflow management system 1 includes, for example, a workflow management server (workflow management device) 10, a schedule management server 20, and a user terminal 30. The above-mentioned servers and terminals are capable of transmitting data to each other or receiving data from each other through a network 2. The network 2 includes, for example, a local area network (LAN), the internet, the Internet, and the like, and may also include a wireless network or a wired network. The user terminal 30 may directly access the workflow management server 10 or the schedule management server 20 through the network 2. Alternatively, in a case where the user terminal 30 is arranged in the intranet of a customer environment, the user terminal 30 may access the network 2 via a proxy server to access the workflow management server 10 or the schedule management server 20, for example.

The workflow management server 10 is a server that manages a workflow set by using the user terminal 30.

The schedule management server 20 is a server that manages a schedule of each user.

The user terminal 30 is an information processing device for executing (registering) a workflow with respect to the schedule management server 20.

The workflow management server 10 may be configured by a single server device (information processing device) or may be configured by a plurality of information processing devices. This also applies to the schedule management server 20.

Hardware Configuration of Workflow Management Server

FIG. 2 is a block diagram illustrating an example of a hardware configuration of the workflow management server 10 or the like according to the present embodiment of the disclosure. The hardware configuration of the workflow management server 10 according to the present embodiment is described below with reference to FIG. 2.

As illustrated in FIG. 2, the workflow management server 10 includes, for example, a central processing unit (CPU) 501, a read only memory (ROM)502, a random access memory (RAM) 503, an auxiliary storage device 505, a medium drive 507, a display 508, a network interface (I/F) 509, a keyboard 511, a mouse 512, and a Digital Versailles Disc (DVD) drive 514.

The CPU 501 is a processor that controls the workflow management server 10. The ROM 502 is a non-volatile storage device that stores a program for the workflow management server 10. The RANI 503 is a volatile storage device used as a work area of the CPU 501.

The auxiliary storage device 505 is a storage device such as, for example, a hard disk drive (HDD) or a solid state drive (SSD) that stores various programs and data. The medium drive 507 reads or writes (stores) data with respect to a recording medium 506, such as a flash memory, under control of the CPU 501.

The display 508 is a display device including a liquid crystal, an organic Electro-Luminescence (EL), or the like that displays various information such as a cursor, a menu, a window, characters, or an image.

The network I/F 509 is an interface for communicating with other devices via the network 2. The network I/F 509 is, for example, a Network Interface Card (NIC) compliant with Ethernet (registered trademark) and is capable of establishing communications in compliance with Transmission Control Protocol (TCP)/Internet protocol (IP).

The keyboard 511 is an input device used for selecting characters, numbers, various commands, moving a cursor, and the like. The mouse 512 is an input device used for selecting commands from options or executing commands, selecting a subject to be processed, moving a cursor, and the like.

The DVD drive 514 is a device that reads or writes data with respect to a DVD 513 such as a DVD-ROM or a Digital Versailles Disc Recordable (DVD-R), which is an example of a removable storage medium (recording medium).

The CPU 501, the ROM 502, the RAM 503, the auxiliary storage device 505, the medium drive 507, the display 508, the network I/F 509, the keyboard 511, the mouse 512, and the DVD drive 514 are connected to each other to enable communication through a bus line 510 such as an address bus or a data bus.

Note that the hardware configuration of the workflow management server 10 illustrated in FIG. 2 is an example and may not include all the components illustrated in FIG. 2 or may include other components. Further, the workflow management server 10 is not limited to being configured by a single information processing device as described above and illustrated in FIG. 2. The workflow management server 10 may be configured by a plurality of network devices such as a plurality of information processing devices.

Further, the hardware configurations of each of the schedule management server 20 and the user terminal 30 is substantially the same as that of the workflow management server 10 as illustrated in FIG. 2.

Configuration and Operation of Functional Blocks of Workflow Management System

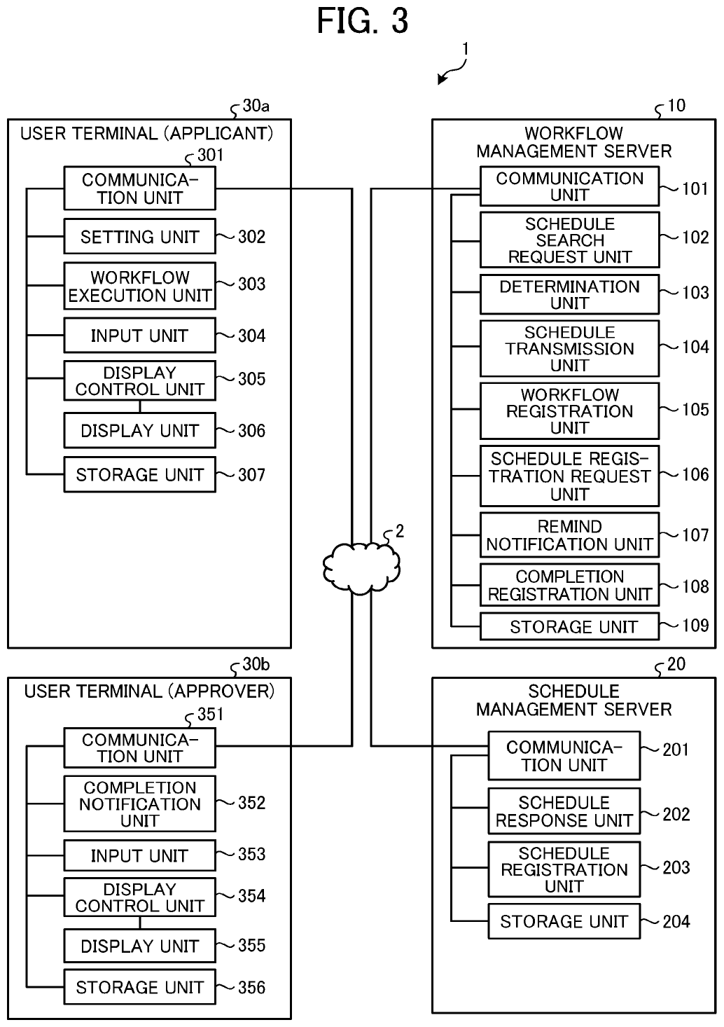

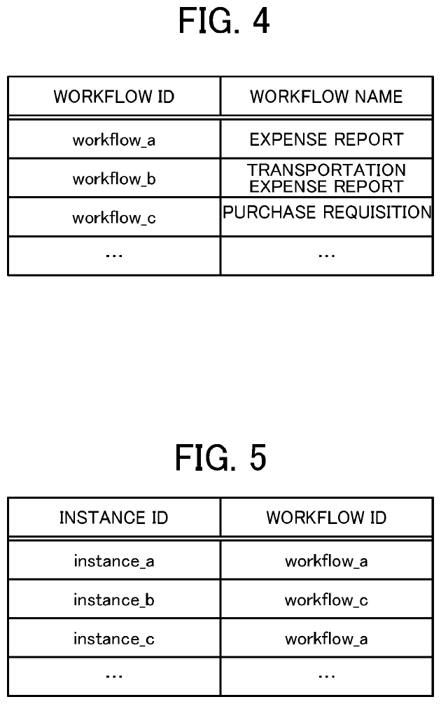

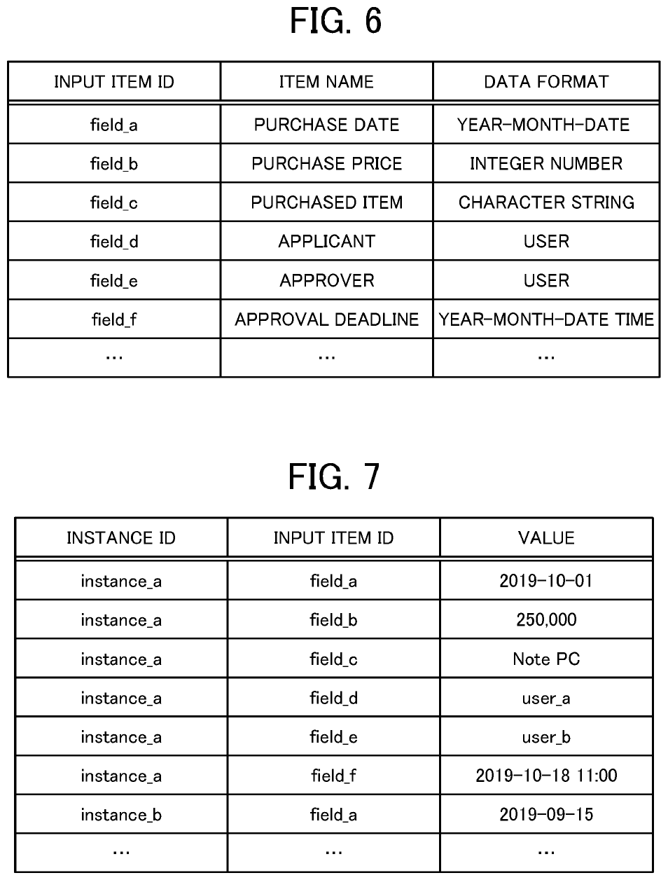

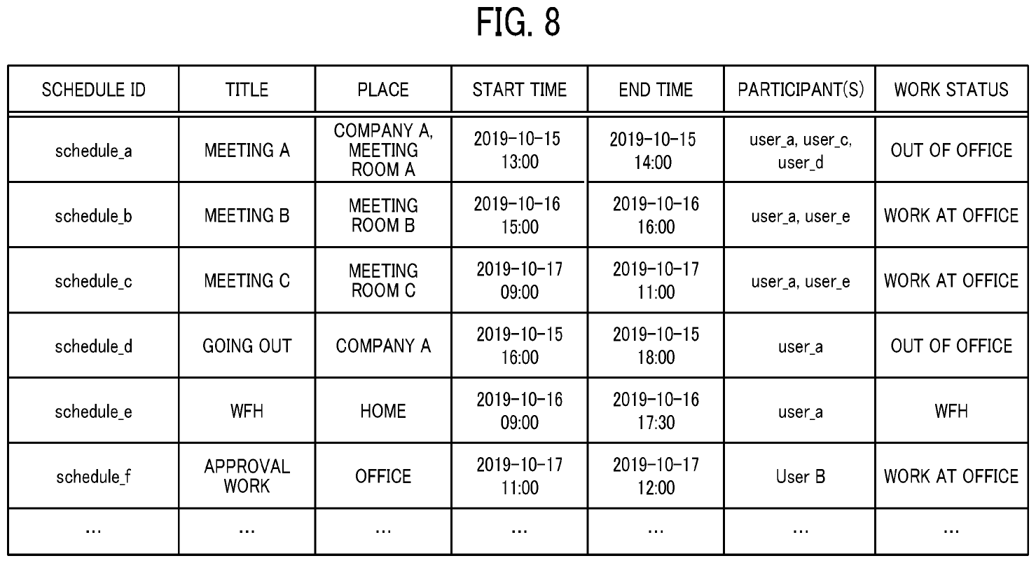

FIG. 3 is a diagram illustrating an example of a functional block configuration of the workflow management system 1 according to the present embodiment of the disclosure. FIG. 4 is a conceptual diagram illustrating an example of a workflow table, according to the present embodiment. FIG. 5 is a conceptual diagram illustrating an example of a workflow instance table, according to the present embodiment. FIG. 6 is a conceptual diagram illustrating an example of an input item table, according to the present embodiment. FIG. 7 is a conceptual diagram illustrating an example of a workflow instance input value table, according to the present embodiment. FIG. 8 is a conceptual diagram illustrating an example of a schedule table, according to the present embodiment. A description is given below of the configuration and operation of the functional blocks of the workflow management system 1 according to the present embodiment with reference to FIG. 3 to FIG. 8.

As illustrated in FIG. 3, the workflow management server 10 includes, for example, a communication unit 101 (an example of a second acquisition unit), a schedule search request unit 102 (first acquisition unit), a determination unit 103, a schedule transmission unit (transmission unit, first transmission unit) 104, a workflow registration unit (generation unit) 105, a schedule registration request unit 106, a remind notification unit (notification unit) 107, a completion registration unit (registration unit) 108, and a storage unit 109.

The communication unit 101 is a functional unit that performs data communication with the schedule management server 20 and the user terminal 30. The communication unit 101 is implemented by executing a program by the CPU 501 illustrated in FIG. 2 and the network I/F 509 illustrated in FIG. 2.

The schedule search request unit 102 is a functional unit that transmits a search request, to the schedule management server 20 via the communication unit 101, to request to search for a schedule of an approver who is set. The schedule search request unit 102 is implemented by executing a program by the CPU 501 illustrated in FIG. 2.

The determination unit 103 is a functional unit that determines one or more tasks that require an approval process in a workflow, which is set, and determines, based on schedule information, one or more time periods in which the approver is at the office (comes to the office to work) and is available for performing the one or more tasks. Each time period may include one or more time slots. The determination unit 103 is implemented by executing a program by the CPU 501 illustrated in FIG. 2.

The schedule transmission unit 104 is a functional unit that transmits, to the user terminal 30 of an applicant via the communication unit 101, schedule information of the approver. The schedule information of the approver indicates at least one period of time having one or more time slots in which the approver is at the office and is available, determined by the determination unit 103. The schedule transmission unit 104 is implemented by executing a program by the CPU 501 illustrated in FIG. 2.

The workflow registration unit 105 is a functional unit that receives a workflow execution request from the applicant and registers information on a workflow (workflow information) in the storage unit 109. The workflow registration unit 105 is implemented by executing a program by the CPU 501 illustrated in FIG. 2.

The schedule registration request unit 106 is a functional unit that transmits a registration request to the schedule management server 20 via the communication unit 101. The schedule registration request unit 106 requests to register, as selection information (schedule information), reservation information that indicates a work time for the approval process performed by the approver. The work time is a time slot selected and set by using the user terminal 30 of the applicant. The schedule registration request unit 106 is implemented by executing a program by the CPU 501 illustrated in FIG. 2.

The remind notification unit 107 is a functional unit that transmits, to the user terminal 30 of the approver, a notification that reminds the approval process, a predetermined period before the work date and time of the approver, which is reserved for the approval process in the workflow. The predetermined period, which is a predetermined time, may be set by a user who may be the applicant, for example. The remind notification unit 107 is implemented by executing a program by the CPU 501 illustrated in FIG. 2.

The completion registration unit 108 is a functional unit that reflects (registers) a completion notification, which is received via the communication unit 101 in response to the approval process being performed by using the user terminal 30 of the approver, in the workflow information stored in the storage unit 109. The completion registration unit 108 is implemented by executing a program by the CPU 501 illustrated in FIG. 2.

The storage unit 109 is a functional unit that stores the workflow information and the like. Further, the storage unit 109 stores a workflow table as illustrated in FIG. 4, a workflow instance table as illustrated in FIG. 5, an input item table as illustrated in FIG. 6, and a workflow instance input value table as illustrated in FIG. 7.

The workflow table illustrated in FIG. 4 is a table that associates a workflow identification (ID) that identifies a workflow type with a workflow name. For example, in FIG. 4, a workflow ID of “workflow_b” and a workflow name of “TRANSPORTATION EXPENSE REPORT” are associated with each other.

The workflow instance table illustrated in FIG. 5 is a table that associates an instance ID that identifies a workflow instance identified by a workflow ID with the workflow ID. The workflow information described above is an instance of the corresponding workflow identified by a specific workflow ID, and is identified by an instance ID. For example, in FIG. 5, an instance ID of “instance_b” and a workflow ID of “workflow_c” are associated with each other.

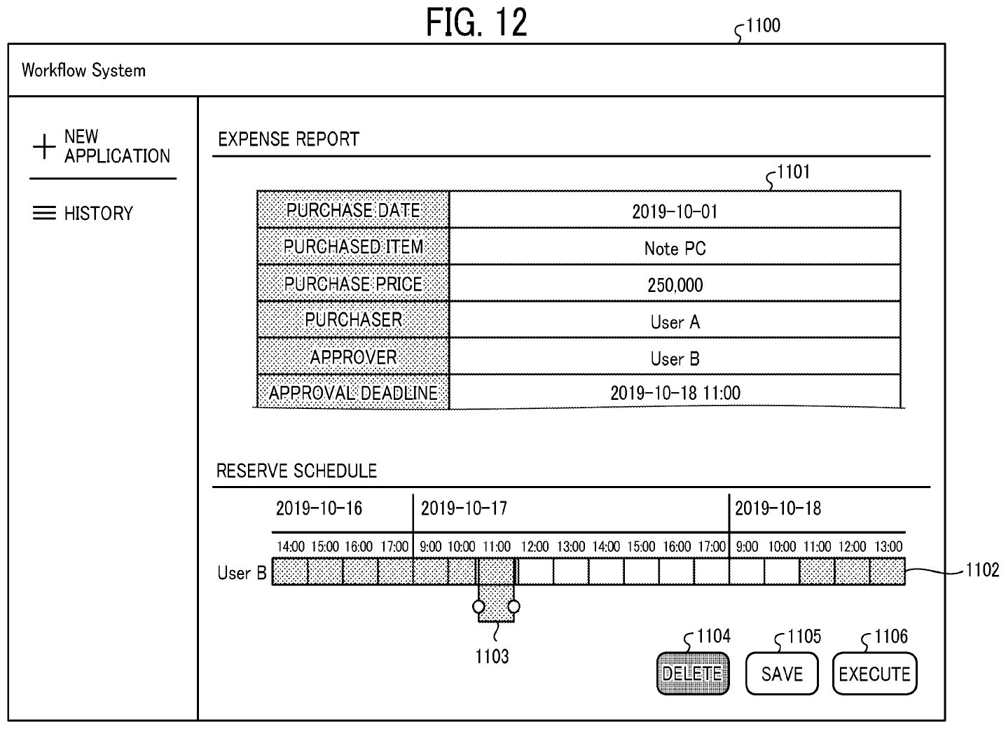

The input item table illustrated in FIG. 6 is a table that associates an input item ID, an item name, and a data format each other. The input item ID identifies each input item of an application detail input section 1101 on a workflow input screen 1100 illustrated in FIG. 12, which is described later. Each input item is able to be input with a corresponding data format that is associated with the input item ID. For example, in FIG. 6, an input item ID of “field_b”, an item name of “PURCHASE PRICE”, and a data format of “INTEGER NUMBER” are associated with each other.

The workflow instance input value table illustrated in FIG. 7 is a table that manages the values each of which is input in the corresponding input item in an application detail input section 1101 on the workflow input screen 1100 illustrated in FIG. 12, which is described later. That is, the workflow instance input value table associates the instance ID that identifies the workflow instance, the input item ID, and the value actually input to the input item. For example, in FIG. 7, an instance ID of “instance_a”, an input item ID of “field_c”, and a value of “Note PC” are associated with each other.

Although each table illustrated in FIG. 4 to FIG. 7 has information in a table format, the information is not limited to this, and any information format (for example, information in a Comma-Separated Values (CSV) format) may be used as long as column values of each table are associated with each other.

The storage unit 109 is implemented by the auxiliary storage device 505 illustrated in FIG. 2.

In addition, the functional units illustrated in FIG. 3 of the workflow management server 10 are functions illustrated conceptually, and the functional configuration illustrated in FIG. 3 is not limiting the embodiments of the disclosure. For example, two or more of the functional units, each of which is illustrated as an independent functional unit of the workflow management server 10 in FIG. 3, may be configured as a single functional unit. Alternatively, one of the functional units of the workflow management server 10 illustrated in FIG. 3 may be further divided into two or more functional units.

As illustrated in FIG. 3, the schedule management server 20 includes, for example, a communication unit 201, a schedule response unit 202, a schedule registration unit 203, and a storage unit 204.

The communication unit 201 is a functional unit that performs data communication with the workflow management server 10. The communication unit 201 is implemented by executing a program by the CPU 501 illustrated in FIG. 2 and the network I/F 509 illustrated in FIG. 2.

The schedule response unit 202 is a functional unit that extracts the schedule information of the approver from the schedule table stored in the storage unit 204 in response to a search request, which is a request for a schedule of the approver, received from the workflow management server 10, and transmits (responds with) the schedule information to the workflow management server 10 via the communication unit 201. The schedule response unit 202 is implemented by executing a program by the CPU 501 illustrated in FIG. 2.

The schedule registration unit 203 is a functional unit that reflects (registers), in the schedule table illustrated in FIG. 8, which is described later, as the selection information (schedule information), the reservation information that indicates a work time for the approval process performed by the approver, in response to a registration request received from the workflow management server 10. The work time is a time slot selected and set by using the user terminal 30 of the applicant. The schedule registration unit 203 is implemented by executing a program by the CPU 501 illustrated in FIG. 2.

The storage unit 204 is a functional unit that stores the schedule table as illustrated in FIG. 8 and the like.

The schedule table illustrated in FIG. 8 is a table that manages the schedules of the users (participants). As illustrated in FIG. 8, the schedule table is a table in which a schedule ID for identifying a schedule, a title of content of the schedule (scheduled work), a place where the scheduled work is performed, a start time, which is a scheduled start time of the work, and an end time, which is a scheduled end time of the work, participants involved in the work, and a work status (style) indicating how the participant participate in the work are associated with each other. For example, in FIG. 8, a schedule ID of “schedule_e”, a title of “WORK FROM HOME (WFH)”, a place of “HOME”, a start time of “2019-10-16 09:00”, an end time of “2019-10-16 17:30”, a participant of “user_a”, and a work status of “WFH” are associated with each other.

Although the schedule table illustrated in FIG. 8 is information in a table format, the information is not limited to this, and any information format (for example, information in a CSV format) may be used as long as column values of each table are associated with each other.

The storage unit 204 is implemented by the auxiliary storage device 505 illustrated in FIG. 2.

In addition, the functional units illustrated in FIG. 3 of the schedule management server 20 are functions illustrated conceptually, and the functional configuration illustrated in FIG. 3 is not limiting the embodiments of the disclosure. For example, two or more of the functional units, each of which is illustrated as an independent functional unit of the schedule management server 20 in FIG. 3, may be configured as a single functional unit. Alternatively, one of the functional units of the schedule management server 20 illustrated in FIG. 3 may be further divided into two or more functional units.

As illustrated in FIG. 3, the user terminal 30 of an applicant (referred to as a user terminal 30a) (first terminal device, terminal device) includes, for example, a communication unit (reception unit) 301, a setting unit 302, a workflow execution unit (second transmission unit) 303, an input unit 304, a display control unit 305, a display unit 306, and a storage unit 307.

The communication unit 301 is a functional unit that performs data communication with the workflow management server 10 and the like. The communication unit 301 is implemented by executing a program by the CPU 501 illustrated in FIG. 2 and the network I/F 509 illustrated in FIG. 2.

The setting unit 302 is a functional unit that makes various settings based on operations performed by the input unit 304 on the workflow input screen 1100, which is described later. The setting unit 302 is implemented by executing a program by the CPU 501 illustrated in FIG. 2.

The workflow execution unit 303 is a functional unit that executes a workflow in which various input items are set. The workflow execution unit 303 is implemented by executing a program by the CPU 501 illustrated in FIG. 2.

The input unit 304 is a functional unit that receives an input operation performed by the applicant. The input unit 304 is implemented by at least one of the keyboard 511 and the mouse 512 illustrated in FIG. 2.

The display control unit 305 is a functional unit that controls the display unit 306 that performs the display operation. The display control unit 305 is implemented by executing a program by the CPU 501 illustrated in FIG. 2.

The display unit 306 is a functional unit that displays various screens and the like under control of the display control unit 305. The display unit 306 is implemented by the display 508 illustrated in FIG. 2.

The storage unit 307 is a functional unit that stores various programs and various types of data. The storage unit 307 is implemented by the auxiliary storage device 505 illustrated in FIG. 2.

In addition, the functional units illustrated in FIG. 3 of the user terminal 30a are functions illustrated conceptually, and the functional configuration illustrated in FIG. 3 is not limiting the embodiments of the disclosure. For example, two or more of the functional units, each of which is illustrated as an independent functional unit of the user terminal 30a in FIG. 3, may be configured as a single functional unit. Alternatively, one of the functional units of the user terminal 30a illustrated in FIG. 3 may be further divided into two or more functional units.

As illustrated in FIG. 3, the user terminal 30 of an approver (referred to as a user terminal 30b) (second terminal device) includes, for example, a communication unit (reception unit) 351, a completion notification unit 352, an input unit 353, a display control unit 354, a display unit 355, and a storage unit 356.

The communication unit 351 is a functional unit that performs data communication with the workflow management server 10 and the like. The communication unit 351 is implemented by executing a program by the CPU 501 illustrated in FIG. 2 and the network I/F 509 illustrated in FIG. 2.

The completion notification unit 352 is a functional unit that transmits to the workflow management server 10 via the communication unit 351 a notification indicating that the approval process is completed when the approver completes the approval process via the input unit 353. Namely, the notification is a completion notification indicating completion of the approval process. The completion notification unit 352 is implemented by executing a program by the CPU 501 illustrated in FIG. 2.

The input unit 353 is a functional unit that receives an input operation performed by the approver. The input unit 353 is implemented by at least one of the keyboard 511 and the mouse 512 illustrated in FIG. 2.

The display control unit 354 is a functional unit that controls the display unit 306 that performs the display operation. The display control unit 354 is implemented by executing a program by the CPU 501 illustrated in FIG. 2.

The display unit 355 is a functional unit that displays various screens and the like under control of the display control unit 354. The display unit 355 is implemented by the display 508 illustrated in FIG. 2.

The storage unit 356 is a functional unit that stores various programs and various types of data. The storage unit 356 is implemented by the auxiliary storage device 505 illustrated in FIG. 2.

In addition, the functional units illustrated in FIG. 3 of the user terminal 30b are functions illustrated conceptually, and the functional configuration illustrated in FIG. 3 is not limiting the embodiments of the disclosure. For example, two or more of the functional units, each of which is illustrated as an independent functional unit of the user terminal 30b in FIG. 3, may be configured as a single functional unit. Alternatively, one of the functional units of the user terminal 30b illustrated in FIG. 3 may be further divided into two or more functional units.

Workflow Process

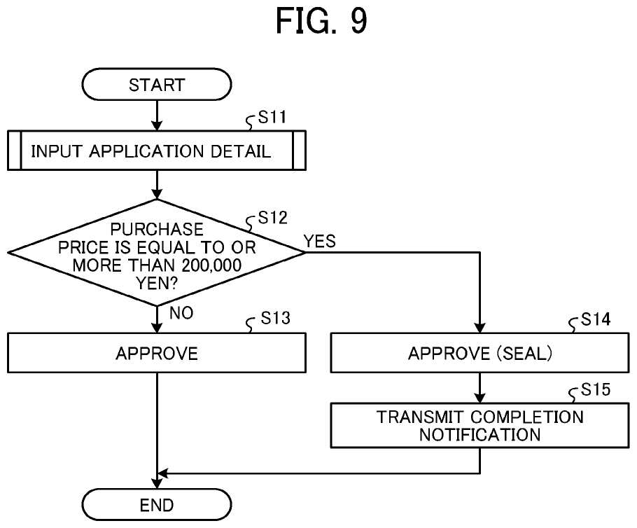

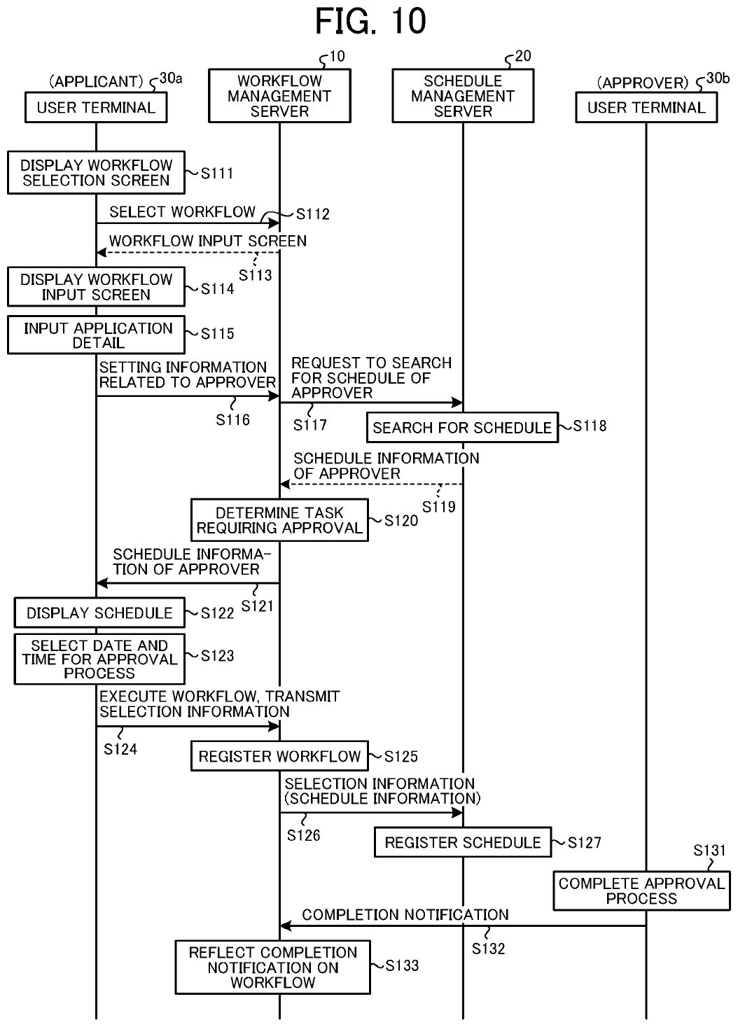

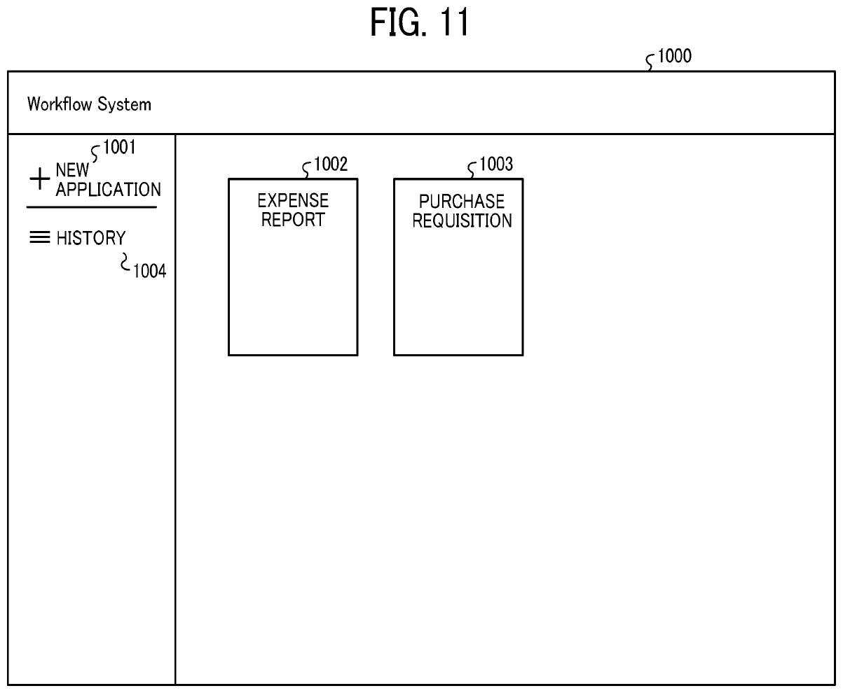

FIG. 9 is a flowchart illustrating an example of how a workflow is performed, according to the present embodiment of the disclosure. FIG. 10 is a sequence diagram of an example of an execution process of a workflow, according to the present embodiment. FIG. 11 is an illustration of an example of a workflow selection screen, according to the present embodiment. FIG. 12 is an illustration of an example of a workflow input screen, according to the present embodiment. A description is given below of a flow of an expense report workflow, as an example of the workflow, with reference to FIG. 9 to FIG. 12.

<Step S11>

An applicant inputs application detail for an expense report to execute the workflow. A process of executing the workflow is described below with reference to steps S111 to S127 illustrated in FIG. 10.

<<Step S111>>

The display control unit 305 of the user terminal 30a causes the display unit 306 to display, for example, a workflow selection screen 1000 illustrated in FIG. 11, in response to a user operation performed by the applicant with respect to the input unit 304.

As illustrated in FIG. 11, the workflow selection screen 1000 is a screen for selecting a workflow to be executed and for which settings are to be set. As illustrated in FIG. 11, the workflow selection screen 1000 includes a new application button 1001, an expense report button 1002, a purchase requisition button 1003, and a history button 1004.

The new application button 1001 is a button for selecting a workflow to be executed. Specifically, when the new application button 1001 is pressed, buttons for selecting each workflow (in the example of FIG. 11, the expense report button 1002 and the purchase requisition button 1003) are displayed, as illustrated in FIG. 11.

The expense report button 1002 is a button for selecting an expense report workflow, as the workflow to be executed. The purchase requisition button 1003 is a button for selecting a purchase requisition workflow as the workflow to be executed.

The history button 1004 is a button for viewing the details of the workflows that have already been registered (executed).

<<Step S112>>

In the present embodiment, it is assumed that the applicant presses the expense report button 1002 via the input unit 304. When the expense report button 1002 is pressed, the setting unit 302 of the user terminal 30a transmits to the workflow management server 10 via the communication unit 301 information indicating that the expense report workflow has been selected.

<<Step S113>>

When the communication unit 101 of the workflow management server 10 receives from the user terminal 30a the information indicating that the expense report workflow has been selected, the communication unit 101 transmits screen information of the workflow input screen 1100 illustrated in FIG. 12 to the user terminal 30a.

<<Step S114>>

When the communication unit 301 receives the screen information of the workflow input screen 1100, the display control unit 305 of the user terminal 30a causes the display unit 306 to display the workflow input screen 1100.

As illustrated in FIG. 12, the workflow input screen 1100 is a screen for inputting application detail for the expense report workflow and reserving a date and time for the approval process to be performed by the approver to execute the expense report workflow. As illustrated in FIG. 12, the workflow input screen 1100 includes the application detail input section 1101, a schedule display section 1102, a selection cursor 1103, a delete button 1104, a save button 1105, and an execute button 1106.

The application detail input section 1101 is an input section for inputting application detail. Specifically, as illustrated in FIG. 12, as the application detail of the expense report workflow, a purchase date when an item was purchased, a purchased item which is a product or a service purchased, a purchase price, a purchaser who purchased the item, an approver who is to approve the expense report, and an approval deadline (an example of work deadline), which is a deadline for the approval process performed by the approver, are input. In the example of FIG. 12, “2019-10-01” is input as the purchase date, “Note PC” is input as the purchased item, “250,000” is input as the purchase price, “User A” (that is, the applicant who applies the expense report by using the user terminal 30a) is input as the purchaser, “User B” (that is, the approver who is to perform the approval process by using the user terminal 30b) is input as the approver, and “2019-10-18 11:00” is input as the approval deadline.

The schedule display section 1102 is a display region for displaying a schedule of the approver (User B). The selection cursor 1103 is a cursor for setting aside (reserving) a time slot for the approval process, which is to be performed by the approver.

The delete button 1104 is a button for deleting the workflow, which is being set. The save button 1105 is a button for saving the application detail input to the application detail input section 1101. The execute button 1106 is a button for executing the workflow with the detail set on the workflow input screen 1100.

<<Step S115, Step S116>>

When the application detail input section 1101 is input with the application detail, and the save button 1105 is pressed by the user, the setting unit 302 of the user terminal 30a transmits, to the workflow management server 10 via the communication unit 301, information on the approver (setting information related to an approver) among the application detail input to the application detail input section 1101.

<<Step S117>>

When the communication unit 101 of the workflow management server 10 receives the setting information related to an approver, the schedule search request unit 102 of the workflow management server 10 transmits a request for schedule information of the approver to the schedule management server 20 via the communication unit 101.

<<Step S118>>

When the communication unit 201 of the schedule management server 20 receives the setting information related to an approver, the schedule response unit 202 of the schedule management server 20 refers to the schedule table in the storage unit 204 to search for the schedule information of the corresponding user (approver) and extracts the schedule information.

<<Step S119>>

The schedule response unit 202 transmits the extracted schedule information of the approver to the user terminal 30a via the communication unit 201.

<<Step S120>>

The schedule search request unit 102 of the workflow management server 10 acquires the schedule information of the approver via the communication unit 101. Then, the determination unit 103 of the workflow management server 10 determines, among a plurality of tasks of the set workflow, a task that requires to reserve a work time and that is to be performed at a specific place (office, in the example of the present embodiment). In the example of the present embodiment, the determination unit 103 determines that the approval process is the task that requires to reserve the work time among the plurality of tasks in the expense report workflow. Further, the determination unit 103 determines the time, that is at least one period of time, in which the approver is at the office and is available based on the schedule information of the approver acquired by the schedule search request unit 102.

<<Step S121>>

Then, the schedule transmission unit 104 transmits, to the user terminal 30a of the applicant via the communication unit 101, the schedule information of the approver, which includes information indicating a period of time (including one or more time slots) in which the approver is at the office and the approver has no event (the approver is available), determined by the determination unit 103.

<<Step S122>>

When the communication unit 301 of the user terminal 30a receives the schedule information of the approver, which includes the information indicating a period of time (including one or more time slots) that satisfies conditions in which the approver is at the office and the approver has no event (the approver is available), the display control unit 305 of the user terminal 30a reflects the schedule information on the schedule display section 1102 of the workflow input screen 1100 illustrated in FIG. 12.

Specifically, as illustrated in FIG. 12, the display control unit 305 displays, with white cells, time slots in which the approver is at the office and the approver is available, which is indicated by the schedule information, (2019-10-17, 11:00 to 2019-10-18, 11:00), and displays, with gray cells, the other time slots than the above-described time slots (namely, in which the approver is not at the office or has already a plan). In the present embodiment, a single cell represents one hour. For example, the display control unit 305 may cause a position of the selection cursor 1103 be automatically set to select an hour that is the earliest hour (time slot) (2019-10-17, 11:00 to 2019-10-17, 12:00) among the whole time slots in which the approver is at the office and is available. This allows the applicant to select a time slot that comes the earliest among the time slots available for the approval process, which is to be performed by the approver (time slots indicated by the white cells), without manual operation. After that, the position of the selection cursor 1103 may be moved to a desired position among the time slots corresponding to the white cells by an operation performed by the applicant via the input unit 304.

In the present embodiment described above, as the time slots available for the approval process, which is to be performed by the approver, the time slots in which the approver is at the office and the approver has no event (the approver is available) is set, but this is not limiting the embodiment. Further, the determination unit 103 may determine the period of time having one or more time slots available for the approval process, which is to be performed by the approver, by taking into account the approval deadline input by the applicant in the application detail input section 1101. For example, when the schedule information indicates that a period of time in which the approver is at the office and the approver is available is from 2019-10-17-11:00 to 2019-10-18-18:00, and the approval deadline set by the applicant is 2019-10-18-11:00, a period of time of which the end corresponds to the approval deadline (from 2019-10-17-11:00 to 2019-10-18-11:00 illustrated in FIG. 12) may be displayed as the period of time corresponding to the time slots available for the approval process, which is to be performed by the approver. Thereby, the work time (reserved time) for the approval process may be selected by reflecting the approval deadline, which is desired by the applicant, with respect to the time slots available for the approval process, which is to be performed by the approver.

<<Step S123>>

The applicant checks the time slots each of which is selectable as the work time for the approval process, which is to be performed by the approver, and a position of the selection cursor 1103 automatically set to select one of the time slots in the schedule display section 1102 displayed on the workflow input screen 1100. Then, if necessary, the applicant changes the position of the selection cursor 1103 to select a desired time slot and presses the execute button 1106.

<<Step S124>>

When the execute button 1106 is pressed by the applicant, the workflow execution unit 303 of the user terminal 30a transmits, to the workflow management server 10 via the communication unit 301, information including the application detail set via the schedule display section 1102 and the time slot selected as the work time for the approval process (selection information), and thereby the workflow is to be executed.

<<Step S125>>

When the communication unit 101 of the workflow management server 10 receives the information including the application detail and the selection information, the workflow registration unit 105 of the workflow management server 10 generates, as workflow information, an instance of the workflow identified by the workflow ID of “workflow_a” corresponding to the workflow name of “expense report” in the workflow table illustrated in FIG. 4. Then, the workflow registration unit 105 registers, in the workflow instance table illustrated in FIG. 5, an instance ID that is issued to identify the instance. Further, the workflow registration unit 105 generates a record corresponding to the issued instance ID in the workflow instance input value table illustrated in FIG. 7, inputs the input item ID and each value indicated by the application detail to be registered. Further, the workflow registration unit 105 reflects the selected work time indicated by the selection information on the generated workflow information.

<<Step S126>>

Then, the schedule registration request unit 106 of the workflow management server 10 transmits, to the schedule management server 20 via the communication unit 101, a request to register the selection information (reservation information selected as the work time for the approval process) as the schedule information.

<<Step S127>>

When the communication unit 201 of the schedule management server 20 receives the request to register the selection information, the schedule registration unit 203 of the schedule management server 20 registers, as schedule information, the selection information in the schedule table illustrated in FIG. 8. For example, as illustrated in FIG. 8, the selection information is registered as the schedule information including a record in which a schedule ID of “schedule_f”, a title of “APPROVAL WORK”, a place of “OFFICE”, and a start time of “2019-10-17 11:00”, an end time of “2019-10-17 12:00”, a participant of “User B”, and a work status of “WORK AT OFFICE” are associated with each other.

The workflow (expense report workflow) is performed according to the flow of steps S111 to S127 described above. The following description is given with reference to the flowchart of FIG. 9 (when the workflow execution process of step S11 is completed, the process proceeds to step S12).

<Step S12>

When an applied purchase price is less than 200,000 yen (step S12: No), the process proceeds to step S13, and when the applied purchase price is equal to or more than 200,000 yen (step S12: Yes), the process proceeds to step S14. In the case of the workflow input screen 1100 illustrated in FIG. 12, the purchase price input to the application detail input section 1101 is “250,000” (250,000 yen), and the process proceeds to step S14.

<Step S13>

The approval process by the approver in step S13 is assumed to be electronically processable by online during working at the office or from home. Accordingly, the approval process in step S13 is not a target task that requires the work time to be reserved on the schedule display section 1102 illustrated in FIG. 12. When the electronic approval is completed by the approver, the expense report workflow is completed.

<Step S14>

The approver performs the approval process that requires, for example, a seal, according to the time reserved for the approval process (work time set on the workflow input screen 1100 illustrated in FIG. 12) specified in the expense report workflow. Subsequently, the process proceeds to S15.

<Step S15>

At this time, when the approver who has completed the approval process operates the user terminal 30b to complete the approval via the input unit 353 (corresponding to step S131 in FIG. 10). Then, the completion notification unit 352 of the user terminal 30b notifies (transmits) the completion of the approval process (completion notification) to the workflow management server 10 via the communication unit 301 (corresponding to step S132 in FIG. 10). In addition, when the applicant who has set the reservation time for the approval process also desires to know whether the approval process has been completed, the completion notification unit 352 may transmit the completion notification not only to the workflow management server 10 but also to the user terminal 30a used by the applicant. Then, when the completion notification is received by the communication unit 101 of the workflow management server 10, the completion registration unit 108 of the workflow management server 10 reflects (registers) the completion notification in the workflow information stored in the storage unit 109 (corresponding to step S133 in FIG. 10). Accordingly, the expense report workflow ends.

The expense report workflow is executed according to the flow of steps S11 to S15 described above.

For example, when the approval process is not performed by the approver during the work time reserved by the applicant, the workflow management server 10 may transmit a notification indicating that the approval process was not performed to the user terminal 30a used by the applicant. In this case, the applicant may set the workflow again by using the user terminal 30a. Alternatively, the applicant may change the work time in the workflow that has already been set and reserve with a new work time.

Example Case of Multiple Tasks Each Requiring Approval Process

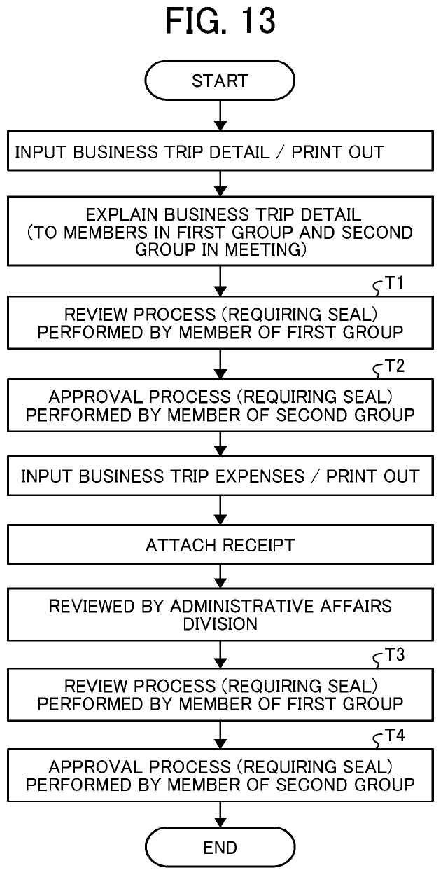

FIG. 13 is a flowchart illustrating an example of a workflow having two or more tasks each of which requires approval, according to one or more embodiments. A description is given below of a case where there are two or more tasks each of which requires an approval process, with reference to FIG. 13.

FIG. 13 is a flowchart illustrating an example of a workflow having two or more tasks each of which requires an approval process, according to the present embodiment. As illustrated in FIG. 13, Task T1 indicates a review process that requires a seal and Task T2 indicates an approval process that requires a seal to accept travel detail explained in the former tasks (steps). This means that each of Tasks T1 and T2 is required to be processed (performed) at the office. In addition, Task T3 indicates a review process that requires a seal and Task T4 indicates an approval process that requires a seal to accept a printed document attached with a receipt corresponding to travel expense detail, which is generated in the former tasks (steps). This means that each of Tasks T3 and T4 is required to be processed (performed) at the office. The above-described tasks are determined by the determination unit 103 as the tasks that require the work times to be reserved (that is, the tasks that are performed at the office).

In the example case in which the applicant carries out the workflow illustrated in FIG. 13, for example, the applicant inputs, in a screen corresponding to the application detail input section 1101 of the workflow input screen 1100, a member of a first group as a reviewer (approver) and a member of a second group as an approver according to the screen input fields. Due to this, four schedule display sections 1102 may be displayed in parallel to reserve (set) a work time for each of the four tasks that are required to be processed at the office (the review process and the approval process). For example, the first group is a group of members (workers) whose positions are fourth level in the organization, and the second group is a group of members (workers) whose positions are third level in the organization. In the example, the workers whose positions are fourth level or more (not general workers) have authority that the general workers do not have. As a result, the work time required by each of the fours tasks required to be processed (performed) at the office is to be reserved.

Example Case of Task Requiring Approval Process Performed at Other Place than Office

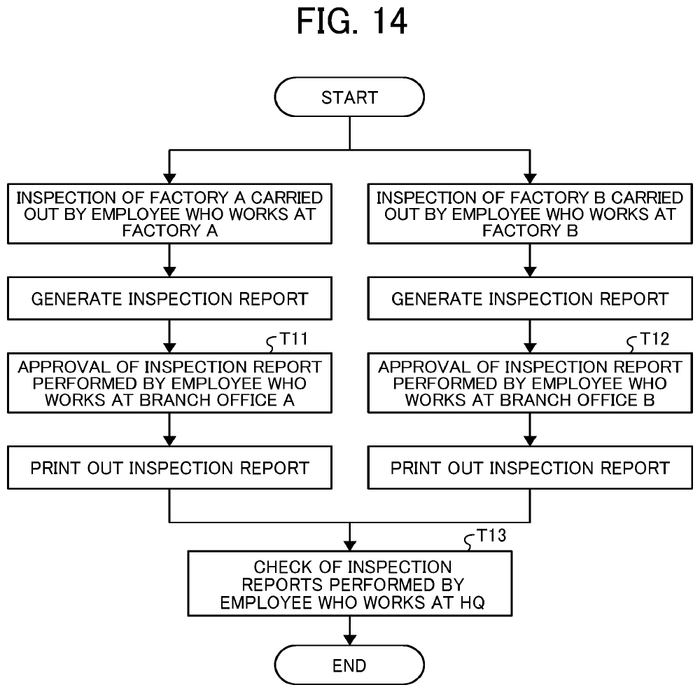

FIG. 14 is a flowchart illustrating an example of a workflow that includes an approval process that is to be performed in a factory according to one or more embodiments. A description is given below of a case where there is a task that requires an approval process that is to be performed in a factory, with reference to FIG. 14.

FIG. 14 is a flowchart illustrating an example of a workflow when there is a task that requires an approval process that is to be performed in a factory, which is not an office. As illustrated in FIG. 14, Task T11 indicates a task of an approval process that is performed at a factory A by an employee who usually works in a branch office A with respect to a report describing an inspection result (check result) of the factory A, which is obtained by the inspection performed in a former step. Further, Task T12 indicates a task of an approval process that is performed at the factory B by an employee who usually works in a branch office B with respect to a report describing an inspection result (check result) of the factory B, which is obtained by the inspection performed in a former step. Further, the task T13 indicates a task of a check process that is performed at the head office (headquarters) by an employee who is at the head office to confirm the inspection reports each of which is approved by the corresponding one of the employee of the branch office A and the employee of the branch office B. The inspection reports are printed out in this step (check process). The above-described tasks are determined by the determination unit 103 as the tasks that require the work times to be reserved (that is, the tasks that are performed at the office or each factory).

In this case in which the applicant carries out the workflow illustrated in FIG. 14, for example, the applicant inputs, in a screen corresponding to the application detail input section 1101 of the workflow input screen 1100, the “employee of the branch office A”, the “employee of the branch office B”, and the “employee of the head office” as the approvers according to the screen input fields. Due to this, the three schedule display sections 1102 may be displayed in parallel to reserve (set) a work time for each of the three tasks that are required to be processed at a specific place (factory or head office) (the approval processes and the check process). Accordingly, the work times each of which is for each process that is to be performed at one of the head office and the factory, which is not the office, may be reserved.

As described above, in the workflow management system 1 according to the present embodiment, tasks that requires to reserve work times for works (for example, approval process) that are required to be performed at two or more places (two or more types of places) as specific places (for example, office, factory, etc.,) in the workflow are determined, and then schedules of workers who are to perform the tasks are extracted in order to reserve the work times. Accordingly, when the task that is to be performed only at a specific place in the workflow is requested to be performed, a date and time when a person who is to perform the task at the specific place is managed and the work time for the task performed by the person, who is a worker, is reserved. That is, it is possible to avoid reserving a time when the worker is not at the specific place as the work time.

In the above-described embodiments, the office and the factory are used as examples of the specific place, and the approval process is used as an example of the work (task), but these are not the limiting of the embodiment. The above-described embodiments are applicable to support a workflow of people working in schools, hospitals, transportation systems, or government offices, for example.

In a conventional technique, for example, a case where a worker, who is an example of an approver of an approval process, does not come to an office, which is a work site, because he or she works from home is not taken into account.

In view of the above, an object of one or more embodiments of the disclosure is to provide a workflow management device, a workflow management system, a workflow management method, and a non-transitory computer-readable recording medium capable of managing a date and time of a worker, who is requested to perform a task that is to be performed at a specific place, determining when the worker is at the specific place, and setting aside a fixed time of the worker for working on, or performing, the task.

According to one or more embodiments of the present disclosure, when a task that is to be performed only at a specific place in a workflow is requested to be performed, it is possible to manage a date and time when a person who is to perform the task is at the specific place and set aside a fixed time of the worker for performing the task.

Each of the functions of the above-described embodiments may be implemented by one or more processing circuits or circuitry. Here, the “processing circuit or circuitry” in the present disclosure includes a programmed processor to execute each function by software, such as a processor implemented by an electronic circuit, and devices, such as an application specific integrated circuit (ASIC), a digital signal processor (DSP), a field programmable gate array (FPGA), a system on a chip (SOC), a graphics processing unit (GPU), and conventional circuit components arranged to perform the recited functions.

Note that, in a case where at least a portion of the functional units of the workflow management server 10 and the user terminal 30 according to any of the above-described embodiments is implemented by execution of a computer program, the program can be prestored in a ROM or the like. Alternatively, the computer program executed in the workflow management server 10 and the user terminal 30 according any of the above-described embodiment can be provided as a file being in an installable format or an executable format and stored in a computer-readable recording medium, such as a compact disc read only memory (CD-ROM), a flexible disk (FD), a compact disc recordable (CD-R), and a digital versatile disk (DVD). Alternatively, the program executed in the workflow management server 10 and the user terminal 30 according to any of the embodiments described above may be stored in a computer connected to a network such as the Internet and downloaded via the network, thus being providable. Alternatively, the program executed in the workflow management server 10 and the user terminal 30 according to any of the embodiments described above may be provided or distributed via a network such as the Internet. The program executed in the workflow management server 10 and the user terminal 30 according any of the above-described embodiment is in the form of module including at least a portion of the above-described functional units. As actual hardware, when the CPU reads out the program from the above-described memory and executes the program, the above-described functional units are loaded and implemented (generated) on a main memory.

Any one of the above-described operations may be performed in various other ways, for example, in an order different from the one described above.

Although the embodiments of the disclosure have been described and illustrated above, such description is not intended to limit the disclosure to the illustrated embodiments. Numerous additional modifications and variations are possible in light of the above teachings. It is therefore to be understood that within the scope of the appended claims, the embodiments may be practiced otherwise than as specifically described herein. For example, elements and/or features of different illustrative embodiments may be combined with each other and/or substituted for each other within the scope of this disclosure and appended claims.

What is claimed is:

1. A workflow management device, comprising
circuitry configured to
acquire schedule information indicating a schedule of a specific person, the specific person being to perform a specific task in a workflow, the specific task being required to be performed at a specific place;
determine, based on the acquired schedule information, at least one period of time in which the specific person is at the specific place and available for performing the specific task, the at least one period of time including one or more time slots; and
transmit information on the at least one period of time to a terminal device used by an applicant of the workflow.

2. The workflow management device according to claim 1,
wherein the circuitry
further acquires, from the terminal device used by the applicant of the workflow, information on a time slot selected from the one or more time slots, and
generates workflow information to which the selected time slot is set.

3. The workflow management device according to claim 1,
wherein the circuitry
further acquires, from the terminal device used by the applicant of the workflow, information on a deadline for the specific task, and
determines, based on the acquired schedule information, the at least one period of time of which an end corresponds to the deadline for the specific task.

4. The workflow management device according to claim 1,
wherein the circuitry
further acquires, from a different terminal device used by the specific person, a completion notification indicating completion of the specific task, and
registers the completion in workflow information.

5. The workflow management device according to claim 1,
wherein the circuitry determines the specific task that is required to be performed at the specific place from a plurality of tasks set in the workflow.

6. The workflow management device according to claim 1,
wherein the specific place includes one or more types of places,
wherein the specific person is one or more specific persons, and
wherein the circuitry
acquires the schedule information of each of the one or more specific persons, and
determines, based on the acquired schedule information, at least one period of time for each of the one or more specific persons, the at least one period of time including one or more time slots in which a corresponding specific person is at one of the one or more types of places and available for performing the specific task in the workflow, and
transmits information on the at least one period of time for each of the one or more specific persons, to the terminal device used by the applicant of the workflow.

7. The workflow management device according to claim 1,
wherein the circuitry transmits a notification to a different terminal device used by the specific person to remind the specific person to perform the specific task, the notification being transmitted a predetermined time before a time slot selected from the one or more time slots for performing the specific task.

8. A workflow management system, comprising:
the workflow management device according to claim 1; and
a terminal device including terminal device circuitry configured to
receive the information on the at least one period of time,
display, on the display, the at least one period of time, and
transmit, to the workflow management device, information on a time slot selected from the one or more time slots via an input device by the applicant.

9. A method of managing a workflow, comprising:
acquiring schedule information indicating a schedule of a specific person, the specific person being to perform a specific task in a workflow, the specific task being required to be performed at a specific place;
determining, based on the acquired schedule information, at least one period of time in which the specific person is at the specific place and available for performing the specific task; and
transmitting information on the at least one period of time to a terminal device used by an applicant of the workflow.

10. A non-transitory recording medium storing a plurality of instructions which, when executed by one or more processors, cause the processors to perform a method, comprising:
acquiring schedule information indicating a schedule of a specific person, the specific person being to perform a specific task in a workflow, the specific task being required to be performed at a specific place;
determining, based on the acquired schedule information, at least one period of time in which the specific person is at the specific place and available for performing the specific task; and
transmitting information on the at least one period of time to a terminal device used by an applicant of the workflow.
